(19) United States
(12) Patent Application Publication
(10) Pub. No.: US 2009/0061239 A1
(43) Pub. Date: Mar. 5, 2009

(54) Use of a latent acid for adhesion promotion

(75) Inventors: Urs Burckhardt, Zurich (CH); Wolf-Rudiger Huck, Zurich (CH); Andreas Braun, Geroldswil (CH)

Correspondence Address: OLIFF & BERRIDGE, PLC, P.O. BOX 320850, ALEXANDRIA, VA, 22320-4850, US

(73) Assignee: SIKA TECHNOLOGY AG, Baar (CH)

(21) Appl. No.: 12/219,289

(22) Filed: Jul. 18, 2008

(30) Foreign Application Priority Data
Aug. 30, 2007 (EP) 07115260.7

(51) Int. Cl. B32B 9/00; C08K 5/42; C09D 7/00; C09J 7/02

(52) U.S. Cl. 428/446; 524/157; 156/329; 106/287.24; 106/287.13

(57) ABSTRACT

The present invention relates to adhesion-promoting compositions comprising a latent acid in a non-aqueous composition, the latent acid by contact with water being convertible into an acid having a pKₐ of less than 2. These compositions have the effect more particularly of promoting the adhesion of adhesives and sealants to paints.

### BACKGROUND

The present invention pertains to the field of adhesion-promoting compositions.

It is known that adhering adhesives and sealants to certain substrates is very difficult to accomplish. Painted surfaces are one such substrate known to be very difficult to bond. Especially critical in this respect are the more recent generations of automotive paints in combination with one-component polyurethane adhesives.

Against this background, numerous pretreatment methods have already been developed for increasing the adhesion to paints. As an example, EP 1 760 129 A1 describes aqueous adhesion cleaning compositions which comprise a strong acid and also a wetting assistant and water and which are intended for pretreatment of a substrate to be bonded or sealed.

In many cases, however, the use of aqueous adhesion promoter compositions to treat a substrate to be bonded or sealed is undesirable, since residual water can undergo an unwanted reaction with moisture-curing adhesives or sealants, and in many cases there are problems owing to excessively long flash-off times, more particularly when operations to accelerate flashing off, such as blowing with dry air, for example, cannot be carried out. Moreover, the use of strong free acids in the preparation and application of adhesion promoter compositions of this kind is associated with significant occupational risks.

### SUMMARY

It is an object of the present invention, therefore, to achieve effective adhesion of adhesives and sealants to substrates to which bonding or sealing is difficult, without having to carry out pretreatment with a strongly acidic aqueous adhesion cleaner composition.

In accordance with the invention this object is achieved by means of the uses defined in Claims 1 and 6. Further aspects of the invention are the method defined in Claim 11, the resultant article according to Claim 20, the pretreatment composition defined in Claim 22, and the adhesive or sealant defined in Claim 29.

Surprisingly it has been found that latent acids which by contact with water are convertible into an acid having a pKₐ of less than 2 open up new possibilities for adhesion promotion. The invention is deployed to particular advantage in the context of its use on paints, more particularly when those paints are automotive paints.

It has additionally emerged that the use of latent acids of this kind produces advantages in terms of workplace safety, more particularly in connection with the preparation and application of the respective compositions, and pretreatment compositions, owing to the retarded release of the acids. Further handling advantages, such as absence of dusting, or easier and more accurate metering possibilities, for example, result from the fact that the majority of latent acids, in contrast to the free acids, are liquid.

It has emerged, moreover, that the use of latent acids rather than free acids has advantageous consequences for the storage stability of compositions, more particularly in moisture-curing adhesives or sealants which are plastically deformable at room temperature.

Finally it has emerged, entirely surprisingly, that a significantly smaller amount of latent acid in comparison to the free acids can be used in order to ensure effective adhesion, at least on paints, this being an advantage in respect more particularly of workplace safety and costs.

Particularly preferred embodiments of the invention are subject matter of the dependent claims.

### DETAILED DESCRIPTION OF EMBODIMENTS

A first aspect of the invention concerns the use of a latent acid which by contact with water is convertible into an acid having a pKₐ of less than 2, in a non-aqueous composition, in order to promote the adhesion to a substrate to be bonded or sealed.

In chemistry, “pKₐ”, as is known, is the negative base-ten logarithm of the acid dissociation constant Kₐ:

pKₐ=−log₁₀ Kₐ

A latent acid which by contact with water is convertible into an acid having a pKₐ of less than 2 represents a compound which in a non-aqueous environment shows no acidic behaviour but on contact with water or moisture is hydrolyzed to a strong acid. This produces the possibility, more particularly, of triggering an inherently desired acid effect only at a given point in time, by supplying water or moisture.

Suitability as latent acid is possessed on the one hand by anhydrides, examples being carboxylic anhydrides such as trifluoroacetic anhydride or trichloroacetic anhydride, and, more particularly, sulphonic anhydrides such as p-toluenesulphonic anhydride, methanesulphonic anhydride or nonafluorobutanesulphonic anhydride.

Particular suitability as latent acid is possessed, on the other hand, by trialkylsilyl sulphonates, more particularly trimethylsilyl benzenesulphonate, trimethylsilyl methanesulphonate, trimethylsilyl trifluoromethanesulphonate, trimethylsilyl vinylsulphonate, trimethylsilyl dodecylsulphonate, trimethylsilyl p-toluenesulphonate, trimethylsilyl dodecylbenzenesulphonate, trimethylsilyl 1-naphthalenesulphonate, trimethylsilyl dinonylnaphthalenesulphonate, bis(trimethylsilyl) dinonylnaphthalenedisulphonate, triethylsilyl methane-sulphonate or tert-butyldimethylsilyl benzenesulphonate.

The most-preferred latent acid is trimethylsilyl benzenesulphonate. In an aqueous environment or in the presence of moisture, trimethylsilyl benzene-sulphonate is hydrolyzed to benzenesulphonic acid and trimethylsilanol. Benzenesulphonic acid is a strong acid having a pKₐ of approximately 0.7 (Handbook of Chemistry and Physics, CRC Press, Boca Raton, USA).

The latent acid is employed more particularly in the fields of use that are described below:
in activators
in primers
in adhesives or sealants.

### Use of Latent Acids in Activators:

In one embodiment the latent acid is used in a non-aqueous composition suitable as an activator, the non-aqueous composition comprising at least one organic solvent and being suitable for pretreating the substrate.

An “activator” in the present document is an adhesion-promoting composition which can be used to pretreat a substrate and whose distinctive features are that it contains no binder and, after flashing off, leaves a film of less than 2 micrometres' thickness on the substrate. After the activator has been flashed off a film is typically left which has a thickness of 0.5 micrometre or less, and which more particularly is composed of a few molecular layers. The pretreatment of the substrate with the activator has the effect, on the one hand, of cleaning the substrate surface and, on the other hand, of improving the adhesion to a subsequently applied layer, more particularly an adhesive or sealant. In general the activator is applied to the substrate surface with an impregnated cloth and thereafter is either flashed off or wiped off with a clean, dry cloth.

The organic solvent is preferably a volatile organic solvent, more particularly from the group of the esters, alcohols, ketones and hydrocarbons. Preference is given to organic solvents having a boiling point of less than 100° C. (at standard pressure). With particular preference the organic solvent is selected from the group consisting of methyl acetate, ethyl acetate, butyl acetate, methanol, ethanol, isopropanol, butanol, acetone, methyl ethyl ketone, hexane, heptane, toluene, xylene and white spirit. Maximum preference as organic solvent is given to alcohols, more particularly isopropanol.

The quantitative proportion of the latent acid is preferably 0.1% to 10% by weight, based on the non-aqueous composition.

### Use of Latent Acids in Primers:

In one embodiment the latent acid is used in a non-aqueous composition suitable as a primer, the non-aqueous composition comprising at least one binder and at least one organic solvent.

A “primer” in the present document is an adhesion-promoting composition which is suitable as an undercoat and which is capable, following its application and curing, of forming a solid, well-adhering film in a thickness of at least 2 micrometres, more particularly of between 2 and 100 μm, preferably of 10-20 μm, on a substrate. In this case the curing comes about either solely through the evaporation of the solvent, or through a chemical reaction, or through a combination of these factors. The primer ensures effective adhesion to a subsequently applied layer, more particularly an adhesive or sealant.

The binder is preferably a reactive binder and comprises more particularly a polymer or oligomer containing isocyanate groups and/or alkoxysilane groups and/or epoxide groups.

The organic solvent is preferably a volatile organic solvent, more particularly from the group of the esters, alcohols, ketones and hydrocarbons. Preference is given to organic solvents having a boiling point of less than 100° C. (at standard pressure). With particular preference the organic solvent is selected from the group consisting of methyl acetate, ethyl acetate, butyl acetate, acetone, methyl ethyl ketone, hexane, heptane, toluene, xylene and white spirit. Maximum preference as organic solvent is given to ethyl acetate and methyl ketone.

The quantitative proportion of the latent acid is preferably 0.1% to 10% by weight, based on the non-aqueous composition.

### Use of Latent Acids in Adhesives or Sealants:

In a further embodiment the latent acid is used in a non-aqueous composition which is suitable as an adhesive or sealant that is plastically deformable at room temperature, the non-aqueous composition comprising at least one reactive polymer.

An adhesive or sealant which is plastically deformable at room temperature can be applied at room temperature and is therefore a contrast to what are known as warm melts (warm-melt adhesives) or hotmelts (hot-melt adhesives), which are not plastically deformable at room temperature and for application must be heated to an elevated temperature (60-80° C. for warm melts or 80-200° C. for hotmelts).

The adhesive or sealant is preferably moisture-curing.

The reactive polymer is preferably a polymer containing isocyanate groups and/or alkoxysilane groups, more particularly a polyurethane polymer containing isocyanate groups and/or alkoxysilane groups.

The adhesive or sealant may be one-component or multi-component. Preferably the adhesive or sealant is one-component.

With maximum preference the adhesive or sealant is a moisture-curing one-component polyurethane adhesive or sealant of the kind obtainable commercially, for example, as part of the product line Sikaflex® from Sika Schweiz AG.

As a result of the use of the latent acid the adhesive or sealant features improved adhesion to certain substrates. In the course of the use of the adhesive or sealant described, therefore, it is possible under certain circumstances not to pretreat the substrate to be bonded or sealed with an adhesion-promoting composition, more particularly an activator or primer, especially when the substrate is a painted substrate.

When the non-aqueous compositions described, comprising one of the latent acids described, are being handled, the acid effect begins not immediately but instead with a delay. This has the great advantage that unwanted contact of the compositions with, for example, the human skin or the eye does not produce immediate damage as a result of the corrosive effect of the acid, and, consequently, that a longer time is available for the implementation of counter-measures, such as wiping or rinsing with a harmless solvent, for example. Consequently the use of such compositions is particularly advantageous from the standpoint of occupational hygiene.

A further key advantage of the non-aqueous compositions described is that they are easier to prepare, since the latent acids are usually liquids, unlike the corresponding free acids, a majority of which are solid at room temperature, and the compositions, consequently, can be handled without dusting and can be metered more easily and more precisely.

In a further aspect the invention provides a method of bonding or sealing which comprises the following steps:
a) providing an adhesion-promoting composition comprising a latent acid which is in solution in an organic solvent and which by contact with water is convertible into an acid having a pKₐ of less than 2, and thereafter:
b) applying the composition to a substrate S1;
c) flashing off or wiping off the composition;
d) applying an adhesive or sealant to the flashed-off or wiped off composition;
e) contacting the adhesive or sealant with a substrate S2;
or
b′) applying the composition to a substrate S1;
c′) flashing off or wiping off the composition;
d′) applying an adhesive or sealant to a substrate S2,
e′) contacting the adhesive or sealant with the flashed-off or wiped off composition;
or
b″) applying the composition to a substrate S1;
c″) flashing off or wiping off the composition;
d″) applying an adhesive or sealant between the surfaces of the substrates S1 and S2;
the substrate S2 being composed of the same material as or a different material than the substrate S1, or the substrate S1 and substrate S2 forming one piece.

The latent acid which by contact with water can be converted into an acid having a pKₐ of less than 2, and the organic solvent, have already been described above in detail.

The quantitative proportion of the latent acid is preferably 0.1% to 10% by weight, based on the adhesion-promoting composition.

Where the substrate S2 is the same substrate as S1, it is preferably likewise to be pretreated with the said adhesion-promoting composition. If S2 is a substrate different from S1, it may be necessary, depending on the material and surface of S2, or depending on the adhesive or sealant, likewise to pretreat its surface with the said composition and/or with a different composition, in order to ensure effective adhesion.

It should be noted here that, before the adhesive or sealant is contacted with the surface of the substrate S1, the said surface must be flashed off or wiped in such a way that the solvent has undergone very substantial evaporation. The flash-off time is dependent on the one hand on atmospheric humidity, temperature and movements of air over the surface, and on the other hand on the surface structure and the quantity applied. If a surface is blown with warm dry air, the time taken for the organic solvent to evaporate will be substantially shorter than if no blowing is employed or if flashing off is carried out at a low temperature. Typically it can be assumed that the waiting time between the application of the adhesion-promoting composition and the contacting with the adhesive or sealant is between 1 minute and 15 minutes, more particularly between 1 and 5 minutes.

It is also possible, immediately following the application of the adhesion-promoting composition, to wipe it largely off again with a cloth. This is referred to in the art as “wipe-off”. In these cases the open time is substantially 0 minutes, and the adhesive or sealant can be applied immediately after wiping.

The composition can be applied in a wide diversity of ways, preferably by spraying or by wiping with an impregnated cloth. Following application, or during application, it is also possible for rubbing to take place under applied pressure, in order to assist the cleaning process.

A variety of adhesives or sealants can be used. Depending on the use and service location of the bonded or sealed body, the adhesive or sealant may be epoxy resin-based, polyurethane-based, (meth)acrylate-based or based on silane-terminated polymers (“STP”) or silicones. The systems in question may be, for example, room-temperature-curing adhesives or sealants, hot-melt adhesives (known as hotmelts), dispersion-based adhesives or sealants, or pressure-sensitive adhesives. The adhesive or sealant may be one-component or multi-component. Preferably the adhesive or sealant is one-component. With maximum preference the adhesive is a moisture-curing one-component polyurethane adhesive or sealant, more particularly a moisture-curing one-component polyurethane adhesive of the kind available commercially, for example, as Sikaflex® from Sika Schweiz AG.

After joining has taken place, i.e. after step e) or e′), or d″), there is typically a step f) of curing of the adhesive or sealant, it being possible for this to take place immediately or with a time delay, depending on adhesive or sealant.

A variety of materials can be used as substrates S1 and/or S2, such as, for example, inorganic substrates such as glass, glass ceramic, concrete, mortar, brick, tile, plaster and natural stone such as granite or marble; metals or alloys such as aluminium, steel, non-ferrous metals, galvanized metals; organic substrates such as leather, fabrics, paper, wood, resin-bonded wood-based materials, resin-textile composites, plastics such as polyvinyl chloride (unplasticized and plasticized PVC), acrylonitrile-butadiene-styrene copolymers (ABS), SMC (sheet moulding composites), polycarbonate (PC), polyamide (PA), polyesters, PMMA, polyesters, epoxy resins, polyurethanes (PU), polyoxymethylene (POM), polyolefins (PO), more particularly polypropylene (PP) or polyethylene (PE) surface-treated by plasma, corona or flame treatment, ethylene/propylene copolymers (EPM) and ethylene/propylene-diene terpolymers (EPDM); coated substrates such as powder-coated metals or alloys; and also inks and paints, more particularly automotive paints. The invention is manifested to particular advantage if the at least the substrate S1 is a painted substrate, more particularly a painted metal. Paints are, more particularly, coatings which are applied to other materials, such as plastics, wood, ceramics, glass, concrete, natural stone, metals or alloys, for example. More particularly the paints are automotive paints, especially automotive paints of the newer generation, which often give rise to adhesion problems in the context of bonding with an adhesive or sealant. Paints of this kind may be, for example, CED paints (CED=cathodic electrodeposition) or multi-coat paints. A typical automotive paint has at least one basecoat and one topcoat (finish coat or clearcoat). The paints used may vary from model to model and within different colours of the same model. On these problem paints, in particular, it is possible, by virtue of the present invention, to achieve effective adhesion.

The bonded or sealed articles thus obtained are of diverse kinds. More particularly they are from the field of industrial manufacture; with preference they are means of transport, more particularly cars. They may also be mounted components. Mounted components of this kind are, in particular, prefabricated modular components which are used as modules on the manufacturing line and in particular are mounted or inserted by adhesive bonding. These prefabricated mounted parts are preferably used in the construction of means of transport. Examples of mounted components of this kind are driver's cabs of lorries or of railway engines, or sliding roofs for cars. Also possible, however, are applications in the construction of furniture, white goods, such as washing machines, or parts of buildings, such as facings or lifts.

In a further aspect the invention provides a pretreatment composition which comprises:
i) at least one latent acid which by contact with water is convertible into an acid having a pKₐ of less than 2,
ii) at least one organic solvent, and
iii) at least one additive
   which is selected from the group consisting of colorants, luminescent indicators, adhesion promoters, more particularly titanates and silanes, and surfactants;
   and/or at least one binder.

The latent acid which by contact with water is convertible into an acid having a pKₐ of less than 2, the organic solvent and the binder have already been described above in detail.

In addition to latent acid and organic solvent, this pre-treatment composition further comprises an additive and/or a binder.

The additive is selected from the group consisting of colorants, luminescent indicators, adhesion promoters, more particularly titanates and silanes, and surfactants.

Colorants are substances which give the pre-treatment composition a coloration that is visible to the human eye. The colorant may be in solution or undissolved. More particularly it may be a pigment. Colorants which can be used are known to the skilled person.

Luminescent indicators are substances which, when irradiated with radiation of a certain wavelength, emit radiation of a different wavelength; more particularly they are substances which respond to UV irradiation with luminescence, preferably substances which when irradiated with radiation at a wavelength between 240 and 400 nm respond with luminescence, more particularly fluorescence. The skilled person knows of many luminescent substances of this kind. Suitable luminescent substances are described, for example, in 11 Kirk-Othmer Encyclopedia of Chemical Technology (John Wiley & Sons, 4^{th} Ed., 1994) on pages 227-241.

Through the use of colorants it is possible, for example, to make an easy visual check as to whether a substrate to be sealed or bonded has been treated with the pre-treatment composition or not. If luminescent indicators are used, this can also be done, in particular, with the aid of a source of UV light. This type of detection is especially advantageous when the substrate surfaces in question are visible, i.e. not hidden. Thus it is possible on the one hand to detect that a substrate has been treated with a pre-treatment composition; on the other hand, however, this is not visible to a viewer under normal daylight, and consequently the aesthetic aspect of the substrate is unaffected. This type of detection is of particular interest more particularly for quality assurance and assurance of operational reliability, particularly in the context of industrial applications.

Suitability as luminescent indicators is possessed more particularly by substances which are available commercially under the brand names Uvitex® from Ciba Specialty Chemicals, Lumilux® from Riedel-de Haen GmbH, Blankophor® from Bayer Chemicals, and Ultraphor® from BASF. Preference is given to Uvitex® OB (Ciba Specialty Chemicals).

The use of adhesion promoters, more particularly titanates and silanes, can intensify the adhesion-promoting effect of the pretreatment composition further, or make the pretreatment composition able to be used for a broader range of surfaces. Suitable titanates are those which have at least one substituent attached to the titanium atom via an oxygen-titanium bond, more particularly an alkoxy group, sulphonate group, carboxylate group, dialkyl phosphate group, dialkyl pyrophosphate group or an acetylacetonate group; in the case of two or more substituents, they may all be the same or be a mixture. Examples of suitable titanates are the products available under the trade name Ken-React® from Kenrich Petrochemicals or under the trade name Tyzor® from DuPont. Suitable silanes are aminosilanes, such as, for example, 3-amino-propyltrimethoxysilane, N-(2-aminoethyl)-3-aminopropyltrimethoxysilane, bis[3-(trimethoxysilyl)propyl]amine, N-(2-aminoethyl)-3-aminopropyldimethoxymethylsilane, 4-amino-3,3-dimethylbutyltrimethoxysilane, 1,3,5-tris[3-(trimethoxysilyl)propyl]-1,3,5-triazine-2,4,6(1H,3H,5H)-trione-urea (i.e. tris(3-(trimethoxysilyl)propyl)isocyanurate), and also the corresponding analogues in which the methoxy group is replaced by an ethoxy group or isopropoxy group; mercaptosilanes, such as, for example, 3-mercaptopropyltrimethoxysilane, epoxysilanes, such as, for example, 3-glycidyloxypropyltrimethoxysilane; ureidoalkylsilanes; and adducts of aminosilanes and/or mercaptosilanes with epoxides or epoxysilanes, such as with 3-glycidyloxypropylsilanes, for example.

Surfactants, also called wetting agents, are natural or synthetic compounds which in solutions lower the surface tension of liquids. Surfactants used may be anionic, cationic, nonionic or ampholytic surfactants or mixtures thereof.

Particular suitability is possessed by nonionic surfactants, more particularly alkoxylated alcohols.

With all of the stated additional constituents it should be ensured that their use in the concentration selected does not adversely affect either the storage stability of the pretreatment composition or the adhesion of adhesives or sealants to surfaces treated with the pretreatment composition.

In the case of one preferred pretreatment composition the latent acid is a trialkylsilyl sulphonate, more particularly trimethylsilyl benzenesulphonate.

If the pretreatment composition does not contain a binder, it constitutes an activator. In this case the amount of the organic solvent is advantageously 80%-99.9%, more particularly 90%-99.9%, preferably 90%-99%, by weight, based on the pretreatment composition.

If the pretreatment composition includes a binder, it constitutes a primer. In this case the amount of the organic solvent is advantageously 40%-80% by weight, more particularly 60%-80% by weight, based on the pretreatment composition. The binder is preferably an oligomer or polymer containing isocyanate groups and/or alkoxysilane groups and/or epoxide groups.

In a further aspect the invention provides a moisture-curing adhesive or sealant which is plastically deformable at room temperature, which comprises:
α) at least one trialkylsilyl sulphonate, more particularly trimethylsilyl benzenesulphonate, trimethylsilyl methanesulphonate, trimethylsilyl trifluoromethanesulphonate, trimethylsilyl vinylsulphonate, trimethylsilyl dodecylsulphonate, trimethylsilyl p-toluenesulphonate, trimethylsilyl dodecylbenzenesulphonate, trimethylsilyl 1-naphthalenesulphonate, trimethylsilyl dinonylnaphthalenesulphonate, bis(trimethylsilyl)dinonylnaphthalenedisulphonate, triethylsilyl methanesulphonate or tert-butyldimethylsilyl benzenesulphonate, preferably trimethylsilyl benzenesulphonate;
and
β) at least one reactive polymer, more particularly a polymer containing isocyanate groups and/or alkoxysilane groups, preferably a polyurethane polymer containing isocyanate groups and/or alkoxysilane groups.

The addition of the trialkylsilyl sulphonate which hydrolyzes on moisture contact to form a strong acid produces improved adhesion on the part of the adhesive or sealant without detrimental effect to its other properties, such as, more particularly, the storage stability or the application properties.

Suitability as reactive polymer is possessed more particularly by polymers containing isocyanate groups and/or alkoxysilane groups, preferably polyurethane polymers containing isocyanate groups and/or alkoxysilane groups, of the kind of polymers known very well to the skilled person in the context of their use for polyurethane adhesives and polyurethane sealants.

A suitable polyurethane polymer containing isocyanate groups is obtainable through the reaction of at least one polyol with at least one polyisocyanate.

Suitable polyols are, more particularly polyether polyols, polyester polyols and polycarbonate polyols, and also mixtures of these polyols.

Particularly suitable as polyether polyols are polyoxyalkylenediols and -triols, more particularly polyoxyalkylene diols. Particularly suitable polyoxyalkylene diols and triols are polyoxyethylene diols and triols and also polyoxypropylene diols and triols.

Particular suitability is possessed by polyoxypropylene diols and triols having a degree of unsaturation of less than 0.02 meq/g and a molecular weight in the range from 1000 to 30 000 g/mol, and also polyoxypropylene diols and triols having a molecular weight of 400 to 8000 g/mol. By ‘molecular weight’ or ‘molar weight’ is meant, in the present document, always the molecular weight average Mₙ. More particularly suitable are polyoxypropylene diols having a degree of unsaturation of less than 0.02 meq/g and a molecular weight in the range from 1000 to 12 000, more particularly between 1000 and 8000 g/mol. Polyether polyols of this kind are sold, for example, under the trade name Acclaim® by Bayer.

Likewise particularly suitable are what are known as “EO-endcapped” (ethylene oxide-endcapped) polyoxypropylene diols and triols. These are special polyoxypropylene-polyoxyethylene polyols which are obtained, for example, by subjecting pure polyoxypropylene polyols, after the end of the polypropoxylation, to alkoxylation with ethylene oxide, and having, as a result, primary hydroxyl groups.
Styrene-acrylonitrile- or acrylonitrile-methyl methacrylate-grafted polyether polyols.
Polyester polyols, also called oligoesterols, prepared by known methods, more particularly the polycondensation of hydroxycarboxylic acids or the polycondensation of aliphatic and/or aromatic polycarboxylic acids with dihydric or higher polyhydric alcohols.

Of more particular suitability are polyester polyols which are prepared from dihydric or trihydric, more particularly dihydric, alcohols, such as, for example, ethylene glycol, diethylene glycol, propylene glycol, dipropylene glycol, neopentyl glycol, 1,4-butanediol, 1,5-pentanediol, 3-methyl-1,5-hexanediol, 1,6-hexanediol, 1,8-octanediol, 1,10-decanediol, 1,12-dodecanediol, 1,12-hydroxystearyl alcohol, 1,4-cyclohexanedimethanol, dimer fatty acid diol (dimer diol), neopentyl glycol hydroxypivalate, glycerol, 1,1,1-trimethylolpropane or mixtures of the aforementioned alcohols, with organic dicarboxylic or tricarboxylic acids, more particularly dicarboxylic acids, or their anhydrides or esters, such as, for example, succinic acid, glutaric acid, adipic acid, trimethyladipic acid, suberic acid, azelaic acid, sebacic acid, dodecanedicarboxylic acid, maleic acid, fumaric acid, dimer fatty acid, phthalic acid, phthalic anhydride, isophthalic acid, terephthalic acid, dimethyl terephthalate, hexahydrophthalic acid, trimellitic acid and trimellitic anhydride, or mixtures of the aforementioned acids, and also polyester polyols formed from lactones such as from ε-caprolactone, for example, and starters such as the aforementioned dihydric or trihydric alcohols.

Particularly suitable polyester polyols are polyester diols.
Polycarbonate polyols of the kind obtainable by reaction, for example, of the abovementioned alcohols—those used to synthesize the polyester polyols—with dialkyl carbonates, such as dimethyl carbonate, diaryl carbonates, such as diphenyl carbonate, or phosgene.

Particularly suitable are polycarbonate diols.
Likewise suitable as polyols are block copolymers which carry at least two hydroxyl groups, and which feature at least two different blocks with polyether, polyester and/or polycarbonate structure of the type described above.
Polyacrylate polyols and polymethacrylate polyols.
Polyhydroxy-functional fats and oils, examples being natural fats and oils, more particularly castor oil; or polyols known as oleochemical polyols, obtained by chemical modification of natural fats and oils, examples of such polyols being the epoxy polyesters and epoxy polyethers obtained by epoxidation of unsaturated oils and subsequent ring opening with carboxylic acids or alcohols respectively, or polyols obtained by hydroformylation and hydrogenation of unsaturated oils; or polyols obtained from natural fats and oils by degradation processes such as alcoholysis or ozonolysis and subsequent chemical linking, by transesterification or dimerization, for example, of the resulting degradation products or derivatives thereof. Suitable degradation products of natural fats and oils are, more particularly, fatty acids and fatty alcohols and also fatty acid esters, more particularly the methyl esters (FAME), which may be derivatized, for example, by hydroformylation and hydrogenation to give hydroxy-fatty acid esters.
Polyhydrocarbon polyols, also called oligohydrocarbonols, such as, for example, polyhydroxy-functional polyolefins, polyisobutylenes, polyisoprenes; polyhydroxy-functional ethylene-propylene, ethylene-butylene or ethylene-propylene-diene copolymers, of the kind produced by Kraton Polymers, for example; polyhydroxy-functional polymers of dienes, more particularly of 1,3-butadiene, which can be prepared more particularly from anionic polymerization, among other processes; polyhydroxy-functional copolymers of dienes such as 1,3-butadiene or diene mixtures and vinyl monomers such as styrene, acrylonitrile, vinyl chloride, vinyl acetate, vinyl alcohol, isobutylene and isoprene, examples being polyhydroxy-functional acrylonitrile/butadiene copolymers, which can be produced, for example, from carboxyl-terminated acrylonitrile/butadiene copolymers (available commercially under the name Hycar® CTBN from Noveon) and from epoxides or amino alcohols; and also hydrogenated polyhydroxy-functional polymers or copolymers of dienes.

These stated polyols preferably have an average molecular weight of 250-30 000 g/mol, more particularly of 400-20 000 g/mol, and preferably have an average OH functionality in the range from 1.6 to 3.

Polyisocyanates used for preparing a polyurethane polymer containing isocyanate groups may be commercially customary aliphatic, cycloaliphatic or aromatic polyisocyanates, more particularly diisocyanates.

Suitable diisocyanates are, for example, 1,6-hexamethylene diisocyanate (HDI), 2-methylpentamethylene 1,5-diisocyanate, 2,2,4- and 2,4,4-trimethyl-1,6-hexamethylenediisocyanate (TMDI), 1,10-decamethylene diisocyanate, 1,12-dodecamethylene diisocyanate, lysine diisocyanate and lysine ester diisocyanate, cyclohexane 1,3- and 1,4-diisocyanate and any desired mixtures of these isomers, 1-methyl-2,4- and 1-methyl-2,6-diisocyanatocyclohexane and any desired mixtures of these isomers (HTDI or H₆TDI), 1-isocyanato-3,3,5-trimethyl-5-isocyanatomethylcyclohexane (i.e. isophorone diisocyanate or IPDI), perhydro-2,4′- and perhydro-4,4′-diphenylmethane diisocyanate (HMDI or H₁₂MDI), 1,4-diisocyanato-2,2,6-trimethylcyclohexane (TMCDI), 1,3- and 1,4-bis(isocyanato-methyl)cyclohexane, m- and p-xylylene diisocyanate (m- and p-XDI), m- and p-tetramethyl-1,3- and p-tetramethyl-1,4-xylylene diisocyanate (m- and p-TMXDI), bis(1-isocyanato-1-methylethyl)naphthalene, 2,4- and 2,6-tolylene diisocyanate and any desired mixtures of these isomers (TDI), 4,4′-, 2,4′- and 2,2′-diphenylmethane diisocyanate and any desired mixtures of these isomers (MDI), 1,3- and 1,4-phenylene diisocyanate, 2,3,5,6-tetramethyl-1,4-diiso-cyanatobenzene, naphthalene 1,5-diisocyanate (NDI), 3,3′-dimethyl-4,4′-diisocyanatobiphenyl (TODI), dianisidine diisocyanate (DADI), oligomers and polymers of the aforementioned isocyanates, and also any desired mixtures of the aforementioned isocyanates. Preference is given to MDI, TDI, HDI and IPDI. Particular preference is given to MDI and IPDI.

A polyurethane polymer containing isocyanate groups is prepared in a known way directly from the polyisocyanates and the polyols, or by stepwise adduction processes, of the kind also known as chain extension reactions.

In one preferred embodiment the polyurethane polymer is prepared via a reaction of at least one polyisocyanate and at least one polyol, the isocyanate groups being present in a stoichiometric excess over the hydroxyl groups. Advantageously the ratio between isocyanate groups and hydroxyl groups is 1.3 to 2.5, more particularly 1.5 to 2.2, with the result that a polyurethane polymer containing isocyanate groups is produced.

Suitable polymers containing silane groups (“STP”) are the alkoxysilane group-terminated polyether polymers which are known as “MS polymers” and are typically obtained by hydrosilylation of allyl group-terminated polyether polymers. Also suitable are those alkoxysilane group-terminated polymers which are obtained in a similar way via hydrosilylation reactions and which have as their backbone not exclusively polyether chains but also, proportionally or entirely, polyacrylate chains and/or polyhydrocarbon chains.

Silane group-containing polymers that are additionally suitable are polyurethane polymers containing alkoxysilane groups. These polymers can be prepared, in one embodiment, by reaction of the above-described polyurethane polymers containing isocyanate groups with aminosilanes, more particularly with aminoalkyldialkoxysilanes or aminoalkyltrialkoxysilanes. If at least the stoichiometric amount of aminosilane is used in this reaction, the products are polyurethane polymers which contain no isocyanate groups but only silane groups. If a substoichiometric amount of aminosilane is used, the products are polyurethane polymers which contain both silane groups and isocyanate groups.

Silane group-containing polymers that are additionally suitable are those which are obtained from the reaction of polymers containing OH groups, more particularly OH-terminated polyurethanes, which in turn are obtained by superstoichiometric reaction of polyols with polyisocyanates, with isocyanatosilanes, more particularly with isocyanatoalkyldialkoxysilanes or isocyanatoalkyltrialkoxysilanes.

The adhesive or sealant may include further constituents, more particularly auxiliaries and additives that are typically used in polyurethane compositions, such as, for example, the following constituents:
plasticizers, examples being carboxylic esters such as phthalates, examples being dioctyl phthalate, diisononyl phthalate or diisodecyl phthalate, adipates, dioctyl adipate for example, azelates and sebacates, organic phosphoric and sulphonic esters or polybutenes;
non-reactive thermoplastic polymers, such as, for example, homopolymers or copolymers of unsaturated monomers, more particularly those from the group encompassing ethylene, propylene, butylene, isobutylene, isoprene, vinyl acetate and alkyl(meth)acrylates, more particularly polyethylenes (PE), polypropylenes (PP), polyisobutylenes, ethylene-vinyl acetate copolymers (EVA) and atactic poly-α-olefins (APAO);
organic and inorganic fillers, examples being ground or precipitated calcium carbonates, which where appropriate are coated with fatty acids, more particularly stearates, or else barytes (BaSO₄, also called heavy spar), finely ground quartzes, calcined kaolins, aluminium oxides, aluminium hydroxides, silicas, especially highly disperse silicas from pyrolysis processes, carbon blacks, especially industrially manufactured carbon blacks (referred to below as “carbon black”), PVC powders or hollow spheres;
fibres, of polyethylene for example;
pigments, examples being titanium dioxide or iron oxides;
catalysts which accelerate the reaction of the isocyanate groups, examples being organotin compounds such as dibutyltin diacetate, dibutyltin dilaurate, dibutyltin dichloride, dibutyltin diacetylacetonate and dioctyltin dilaurate, bismuth compounds such as bismuth trioctoate and bismuth tris(neodecanoate), and compounds containing tertiary amino groups, such as 2,2′-dimorpholinodiethyl ether and 1,4-diazabicyclo[2.2.2]octane;
rheology modifiers such as, for example, thickeners or thixotropic agents, examples being urea compounds, polyamide waxes, bentonites or fumed silicas;
reactive diluents and crosslinkers, examples being monomeric diisocyanates and also oligomers and derivatives of these polyisocyanates, adducts of monomeric polyisocyanates with short-chain polyols, and also adipic dihydrazide and other dihydrazides, and also polyisocyanates with blocked isocyanate groups, of the kind already mentioned above;
dryers, such as molecular sieves, calcium oxide, highly reactive isocyanates such as p-tosyl isocyanate, orthoformic esters, and tetraalkoxysilanes such as tetraethoxysilane, for example;
organoalkoxysilanes, also called “silanes” below, such as, for example, epoxysilanes, (meth)acrylosilanes, isocyanatosilanes, vinylsilanes, carbamatosilanes, alkylsilanes, S-(alkylcarbonyl)mercaptosilanes, and oligomeric forms of these silanes;
stabilizers against heat, light and UV radiation;
flame retardants;
surface-active substances such as wetting agents, flow control agents, de-aerating agents or defoamers, for example;
biocides such as, for example, algicides, fungicides or fungal growth inhibitors.

It has been found that there are advantages in terms of storage stability if latent acids are used instead of free acids. This is the case more particularly for moisture-curing adhesives or sealants which are plastically deformable at room temperature. Since strong acids catalytically accelerate the crosslinking reaction, moisture-curing adhesives or sealants which include free strong acids are virtually unstorable, since after just a short storage time the increase in their viscosity is so sharp that they can no longer be applied in the conventional manner. The corresponding adhesives or sealants which comprise a corresponding latent acid are unaffected by this phenomenon. Adhesives and sealants of that kind are storable over relatively long periods of time.

### EXAMPLES

Preparation and testing of adhesion-promoting compositions

The latent acid trimethylsilyl benzenesulphonate and also a series of free acids were dissolved in isopropanol under a nitrogen atmosphere, the concentrations of the latent acids or free acids in the solutions prepared being indicated in the tables in each case (in % by weight). These solutions were used to pretreat metal sheets which had been coated with different commercial automotive paints. After a waiting time (flash-off time) the moisture-curing one-component polyurethane adhesive Sikaflex®-250 DM-2 was applied to the pretreated sites in the form of a bead, using a cartridge gun, and, after curing, the adhesive was tested for adhesion by means of an adhesion test (bead test). In this case an incision is made at the end just above the adhesion face. The incised end of the bead is held with round-end tweezers and pulled from the substrate. This is done by carefully rolling up the bead on the tip of the tweezers, and placing a cut vertical to the bead pulling direction down to the bare substrate. The rate of bead removal is selected so that a cut has to be made approximately every 3 seconds. The test length must amount to at least 8 cm. An assessment is made of the adhesive which remains on the substrate after the bead has been pulled off (cohesive fracture). The adhesion is evaluated by estimating the cohesive component of the adhesion face:

1=>95% cohesive fracture

2=75-95% cohesive fracture

3=25-75% cohesive fracture

4=<25% cohesive fracture

5=0% cohesive fracture (purely adhesive fracture)

Test results with cohesive fracture values of less than 75% are considered inadequate.

Adhesion to automotive paint HDTC 4041

Table 1 specifies compositions, or pre-treatment compositions, which are composed of isopropanol and of the acid which is latent in the amount indicated, or free acid. Preparation takes place by stirred incorporation under an inert atmosphere (N₂). Using the solutions prepared, in accordance with Table 1, a metal sheet coated with the automotive paint HDTC 4041 from PPG was pretreated, by applying the solutions using a cloth and immediately thereafter wiping off again with a dry cloth (“wipe on/off”). After a waiting time of 10 minutes, Sikaflex®-250 DM-2 was applied as a circular bead with a width 5 of 10 mm and was cured under standard conditions (23° C./50% humidity) for 7 days, whereupon the first adhesion test (“RT”) was performed. Thereafter the sheet was immersed in water at 23° C. for 7 days, after which a further adhesion test (“WS”) was performed. Finally the sheet was stored under conditions of 40° C. and 100% for 7 days, after which a further adhesion test (“CS”) was performed. The results are shown in Table 1.

TABLE 1
Compositions and adhesion of Sikaflex ®-250 DM-2 on a
metal sheet, coated with the automotive paint HDTC 4041
from PPG, following pretreatment with a pretreatment
composition comprising latent acid or free acid.

| | Latent acid or | | Wt. | | | |
|---|---|---|---|---|---|---|
| | free acid | Solvent | % | RT | WS | CS |
| Ref.1 | — | isopropanol | — | 5 | 5 | 5 |
| Ref.2 | dodecylbenzene- | isopropanol | 1.0 | 2 | 2 | 2 |
| | sulphonic acid | | | | | |
| Ref.3 | p-toluenesulphonic | isopropanol | 1.0 | 2 | 2 | 2 |
| | acid | | | | | |
| Ref.4 | methanesulphonic | isopropanol | 0.3 | 5 | 5 | 5 |
| | acid | | | | | |
| Ref.5 | hydrochloric acid | isopropanol | 0.5 | 2 | 2 | 2 |
| Ref.6 | sulphuric acid | isopropanol | 0.3 | 3 | 3 | 3 |
| Ref.7 | phosphoric acid | isopropanol | 0.5 | 5 | 5 | 4 |
| Ref.8 | acetic acid | isopropanol | 0.3 | 4 | 4 | 4 |
| Ref.9 | benzoic acid | isopropanol | 0.4 | 4 | 4 | 4 |
| Ref.10 | oxalic acid | isopropanol | 0.3 | 4 | 5 | 5 |
| 1 | trimethylsilyl | isopropanol | 0.7 | 1 | 1 | 1 |
| | benzenesulphonate | | | | | |

As is apparent from Table 1, the adhesion of Sikaflex®-250 DM-2 when using the latent acid trimethylsilyl benzenesulphonate was excellent, whereas, in the case of the free acids, satisfactory adhesion was obtained only in the case of dodecylbenzenesulphonic acid, p-toluenesulphonic acid, methanesulphonic acid, sulphuric acid and hydrochloric acid. No corrosion of the paint was found in the case of Example 1.

In a further series of experiments, then, for the latent acid trimethylsilyl benzenesulphonate and also for the three most effective free acids according to Table 1, a concentration series was used to investigate the concentration range in which the solutions have an adhesion-promoting effect. The systems in question here are also binary mixtures of isopropanol and the free or latent acid, the amount by weight specified likewise referring to the free or latent acid. The results are shown in Table 2.

From Table 2 it is apparent that the adhesion-promoting effect of trimethylsilyl benzenesulphonate in isopropanol is valid in a concentration range from 0.5% to 10% by weight, more particularly 0.7% to 10% by weight. A particular surprise in this context is that, even at a concentration of 0.7% by weight, very good adhesion is obtained with trimethylsilyl benzenesulphonate, whereas for a comparable result the free acids must be used at a significantly higher level. No corrosion of the paint was observed for any of pretreatment compositions 1 to 6.

TABLE 2
Compositions and adhesion of Sikaflex ®-250 DM-2 on a
metal sheet, coated with the automotive paint HDTC 4041
from PPG, following pretreatment with a pretreatment
composition comprising latent acid or free acid.

| latent acid or free acid | wt. % | RT | WS | CS | |
|---|---|---|---|---|---|
| dodecylbenzenesulphonic | 0.3 | 3 | 5 | 5 | Ref.2-1 |
| acid | 0.5 | 2 | 3 | 3 | Ref.2-2 |
| | 1.0 | 2 | 2 | 2 | Ref.2 |
| | 2.5 | 1 | 1 | 1 | Ref.2-3 |
| | 7.0 | 1 | 1 | 1 | Ref.2-4 |
| p-toluenesulphonic acid | 0.7 | 3 | 4 | 4 | Ref.3-1 |
| | 1.0 | 2 | 2 | 2 | Ref.3 |
| | 2.5 | 1 | 1 | 1 | Ref.3-2 |
| | 7.0 | 1 | 1 | 1 | Ref.3-3 |
| | 10 | 1 | 1 | 1 | Ref.3-4 |
| sulphuric acid | 0.1 | 5 | 5 | 5 | Ref.6-1 |
| | 0.3 | 3 | 3 | 3 | Ref.6 |
| | 0.5 | 3 | 2 | 3 | Ref.6-2 |
| | 1.0 | 2 | 2 | 2 | Ref.6-3 |
| trimethylsilyl | 0.5 | 3 | 3 | 3 | 2 |
| benzenesulphonate | 0.7 | 1 | 1 | 1 | 3 |
| | 1.0 | 1 | 1 | 1 | 1 |
| | 2.5 | 1 | 1 | 1 | 4 |
| | 7.0 | 1 | 1 | 1 | 5 |
| | 10 | 1 | 1 | 1 | 6 |

Adhesion to various automotive paints

Metal sheets coated with the automotive paints A to F were pretreated with solutions of the latent acid trimethylsilyl benzenesulphonate and, respectively, with solutions of the free acids dodecylbenzenesulphonic acid and p-toluenesulphonic acid (in each case in the concentrations specified in Table 3 for the free acid or latent acid, in isopropanol), by applying the solutions with a cloth and immediately thereafter wiping off again with a dry cloth (“wipe on/off”). After a waiting time of 10 minutes, Sikaflex®-250 DM-2 was applied as a circular bead with a width of 10 mm and was cured under standard conditions (23° C./50% humidity) for 7 days, whereupon the first adhesion test (“RT”) was performed. Thereafter the sheet was immersed in water at 23° C. for 7 days, after which a further adhesion test (“WS”) was performed. Finally the sheet was stored under conditions of 40° C. and 100% for 7 days, after which a further adhesion test (“CS”) was performed. The results are shown in Table 3.

Automotive paints investigated (topcoats):

TABLE 3
Adhesion of Sikaflex ®-250 DM-2 to metal sheets coated with the automotive
paints A to F, following pretreatment with a pretreatment composition
comprising latent acid or free acid.

| Paint | | | | | | | | | | |
|---|---|---|---|---|---|---|---|---|---|---|
| Latent acid or | | A | | | B | | | C | | |
| free acid | Wt. % | RT | WS | CS | RT | WS | CS | RT | WS | CS |
| — | — | 5 | 5 | 5 | 5 | 5 | 5 | 5 | 5 | 5 |
| Dodecylbenzene- | 2.5 | 1 | 1 | 1 | 1 | 1 | 1 | 1 | 1 | 1 |
| sulphonic acid | | | | | | | | | | |
| p-Toluenesulphonic | 2.5 | 1 | 1 | 1 | 1 | 1 | 1 | 1 | 1 | 1 |
| acid | | | | | | | | | | |
| Trimethylsilyl | 1.5 | 1 | 1 | 1 | 1 | 1 | 1 | 1 | 1 | 1 |
| benzenesulphonate | 3.0 | 1 | 1 | 1 | 1 | 1 | 1 | 1 | 1 | 1 |
| Paint | | | | | | | | | | |
| Latent acid or | | D | | | E | | | F | | |
| free acid | Wt. % | RT | WS | CS | RT | WS | CS | RT | WS | CS |
| — | — | 4 | 4 | 4 | 4 | 4 | 3 | 3 | 3 | 3 |
| Dodecylbenzene- | 2.5 | 1 | 1 | 1 | 1 | 1 | 1 | 1 | 1 | 1 |
| sulphonic acid | | | | | | | | | | |
| p-Toluenesulphonic | 2.5 | 1 | 1 | 1 | 1 | 1 | 1 | 1 | 1 | 1 |
| acid | | | | | | | | | | |
| Trimethylsilyl | 1.5 | 1 | 1 | 1 | 1 | 1 | 1 | 1 | 1 | 1 |
| benzenesulphonate | 3.0 | 1 | 1 | 1 | 1 | 1 | 1 | 1 | 1 | 1 |

A: HDCT 4041 (PPG)
B: HDCT 4031 (PPG)
C: HDCT 4022 (PPG)
D: RK 4126 (DuPont)
E: RK 8045 (DuPont)
F: RK 8046 (DuPont)

1. A method of promoting adhesion, comprising contacting a latent acid with water to convert the latent acid into an acid having a pKₐ of less than 2 in a non-aqueous composition to promote adhesion to a substrate to be bonded or sealed.

2. The method according to claim 1, wherein the non-aqueous composition comprises at least one organic solvent and is suitable for pretreating the substrate.

3. The method according to claim 2, wherein the organic solvent is an alcohol, more particularly isopropanol.

4. The method according to claim 1, wherein the non-aqueous composition further comprises at least one organic solvent and also at least one binder and is suitable as a primer for precoating the substrate.

5. The method according to claim 1, wherein the non-aqueous composition comprises at least one reactive polymer and is suitable for use as a sealant or adhesive which is plastically deformable at room temperature.

6. The method according to claim 5, wherein the reactive polymer is a polyurethane polymer containing isocyanate groups and/or alkoxysilane groups.

7. The method according to claim 1, wherein the quantitative proportion of the latent acid is 0.1% to 10% by weight, based on the non-aqueous composition.

8. The method according to claim 1, wherein the latent acid is an anhydride.

9. The method according to claim 1, wherein the latent acid is a trialkylsilyl sulphonate.

10. The method according to claim 9, wherein the latent acid is trimethylsilyl benzenesulphonate.

11. A method of adhesive bonding or of sealing, comprising the steps of:
a) providing an adhesion-promoting composition comprising a latent acid which is in solution in an organic solvent and which by contact with water is convertible into an acid having a pKₐ of less than 2, and thereafter:
b) applying the composition to a substrate S1;
c) flashing off or wiping off the composition;
d) applying an adhesive or sealant to the flashed-off or wiped off composition;
e) contacting the adhesive or sealant with a substrate S2;
or
b′) applying the composition to a substrate S1;
c′) flashing off or wiping off the composition;
d′) applying an adhesive or sealant to a substrate S2,
e′) contacting the adhesive or sealant with the flashed-off or wiped off composition;
or
b″) applying the composition to a substrate S1;
c″) flashing off or wiping off the composition;
d″) applying an adhesive or sealant between the surfaces of the substrates S1 and S2;
the substrate S2 being composed of the same material as or a different material than the substrate S1, or the substrate S1 and substrate S2 forming one piece.

12. The method according to claim 11, wherein the step e) or e′) or d″) is followed by a step f) of curing the adhesive or sealant.

13. The method according to claim 11, wherein the adhesive or sealant is a moisture-curing one-component polyurethane adhesive or sealant.

14. The method according to claim 11, wherein the substrate S1 is a painted substrate.

15. The method according to claim 11, wherein the latent acid is an anhydride.

16. The method according to claim 11, wherein the latent acid is a trialkylsilyl sulphonate.

17. The method according to claim 11, wherein the latent acid is trimethylsilyl benzenesulphonate.

18. The method according to claim 11, wherein the organic solvent is an alcohol.

19. The method according to claim 11, wherein the quantitative proportion of the latent acid is 0.1% to 10% by weight, based on the adhesion-promoting composition.

20. A bonded or sealed article obtained by a method according to claim 11.

21. A bonded or sealed article according to claim 20, wherein the article is a means of transport, more particularly a car, or a mounted component for a means of transport.

22. A pretreatment composition comprising:
i) at least one latent acid which by contact with water is convertible into an acid having a pKₐ of less than 2,
ii) at least one organic solvent, and
iii) at least one additive which is selected from the group consisting of colorants, luminescent indicators, adhesion promoters and surfactants;
and/or at least one binder.

23. The composition according to claim 22, wherein the latent acid is an anhydride.

24. The composition according to claim 22, wherein the latent acid is a trialkylsilyl sulphonate.

25. The composition according to claim 22, wherein the latent acid is a trialkylsilyl sulphonate.

26. The composition according to claim 22, wherein the amount of the organic solvent is 80%-99.9%, by weight, based on the pretreatment composition.

27. The composition according to claim 22, wherein the pretreatment composition comprises at least one binder and the amount of the organic solvent is 40%-80%, by weight, based on the pretreatment composition.

28. The composition according to claim 22, wherein the binder is a polymer or oligomer containing isocyanate groups and/or alkoxysilane groups and/or epoxide groups.

29. A moisture-curing adhesive or sealant which is plastically deformable at room temperature, comprising:
α) at least one trialkylsilyl sulphonate;
and
β) at least one reactive polymer.
